(19) United States
(12) Patent Application Publication
(10) Pub. No.: US 2025/0300476 A1
(43) Pub. Date: Sep. 25, 2025

(54) CONTROL DEVICE

(71) Applicant: TOYOTA JIDOSHA KABUSHIKI KAISHA, Toyota-shi (JP)

(72) Inventors: Kenji TAKAHASHI, Toyota-shi (JP); Kazuki Kubo, Toyota-shi (JP)

(73) Assignee: TOYOTA JIDOSHA KABUSHIKI KAISHA, Toyota-shi (JP)

(21) Appl. No.: 18/985,051

(22) Filed: Dec. 18, 2024

(30) Foreign Application Priority Data
Mar. 21, 2024 (JP) 2024-044698

(51) Int. Cl. H02J 7/00; H01M 10/0525; H01M 10/44; H01M 10/48

(52) U.S. Cl. CPC H02J 7/00712; H01M 10/0525; H01M 10/443; H01M 10/482; H02J 7/0013

(57) ABSTRACT

The power storage device includes a plurality of kinds of secondary batteries and a control device that determines a discharge order of the secondary batteries. When the value indicating the storage state of the entire secondary battery becomes equal to or smaller than the threshold value, the control device preferentially discharges the low-precision battery having the relatively low estimation accuracy of the storage state, as compared with the high-precision battery having the relatively high estimation accuracy of the storage state.

### CROSS-REFERENCE TO RELATED APPLICATION

This application claims priority to Japanese Patent Application No. 2024-044698 filed on Mar. 21, 2024, incorporated herein by reference in its entirety.

### BACKGROUND

### 1. Technical Field

The present disclosure relates to a control device.

### 2. Description of Related Art

As a method for calculating a power storage state such as a state of charge (SOC) or the remaining charge level of a power storage cell, a current integration method as described in Japanese Unexamined Patent Application Publication No. 2022-132800 (JP 2022-132800 A) is known.

### SUMMARY

In JP 2022-132800 A, when a plurality of power storage cells of the same kind is provided, the power storage states can be estimated with a certain degree of accuracy. When a plurality of power storage cells of different kinds is provided, however, a power storage cell having a high accuracy of estimation of the power storage state by the current integration method and a power storage cell having a low accuracy of estimation of the power storage state by the current integration method may be mixed. In such a case, the accuracy of estimation of the overall power storage state decreases. When the accuracy of estimation of the overall power storage state decreases, it is also assumed that the actual power storage state is less than the estimated power storage state. When the power storage states are estimated while continuing discharge from the power storage cells in this state, a sudden decrease in the estimated values may occur near lower limits.

An object of the present disclosure is to increase the accuracy of estimation of power storage states even when power storage amounts are close to lower limits when estimating the power storage states of a plurality of kinds of secondary batteries.

The present disclosure provides a power storage device including a plurality of kinds of secondary batteries and a control device configured to determine discharge order of the plurality of kinds of secondary batteries. The control device is configured to, when a value indicating an overall power storage state of the plurality of kinds of secondary batteries is equal to or less than a threshold value, discharge a low-accuracy battery included in the plurality of kinds of secondary batteries and having a relatively low accuracy of estimation of a power storage state with priority over a high-accuracy battery included in the plurality of kinds of secondary batteries and having a relatively high accuracy of estimation of a power storage state.

According to the present disclosure, it is possible to increase the accuracy of estimation of the power storage states even when the power storage amounts are close to the lower limits when estimating the power storage states of a plurality of kinds of secondary batteries.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram for explaining a power storage system according to the present embodiment;

FIG. 2 is a flow chart for explaining the process of the integrated ECU shown in FIG. 1; and

FIG. 3 is a flow chart for explaining a process of the battery-integrated ECU shown in FIG. 1.

### DETAILED DESCRIPTION OF EMBODIMENTS

Hereinafter, the present embodiment will be described with reference to the accompanying drawings. In order to facilitate understanding of the description, the same components are denoted by the same reference numerals as much as possible in the drawings, and redundant description will be omitted.

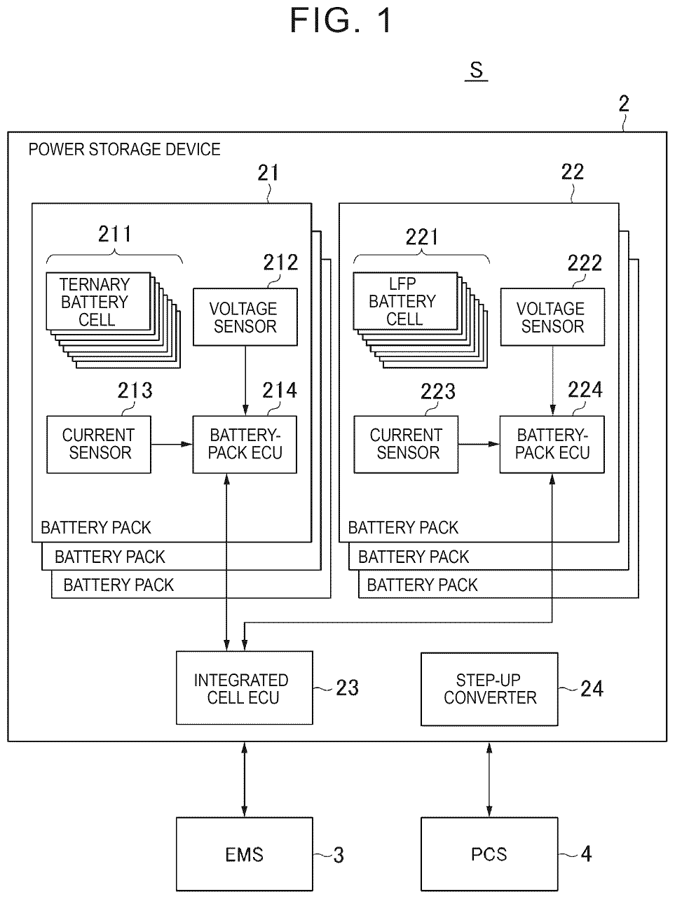

The power storage system S according to the present embodiment will be described with reference to FIG. 1. The power storage system S is a system that stores electric power generated by a power generation facility (including wind power generation, photovoltaic power generation, and the like) (not shown). The power storage system S is also a system that supplies the stored power to a system (not shown). The power storage system S includes a power storage device 2, an EMS (Energy Management System) 3, and a PCS (Power Conditioning System) 4.

EMS 3 outputs a discharging command to the power storage device 2. PCS 4 is an inverter that controls the electric power supplied to the system and converts the DC current input from the power storage device 2 into an AC current.

The power storage device 2 includes a plurality of battery packs 21, a plurality of battery packs 22, a battery integrated ECU 23, and a step-up converter 24. The battery pack 21 includes a ternary battery cell 211, a voltage sensor 212, a current sensor 213, and a battery pack ECU 214.

The ternary battery cell 211 is a ternary lithium ion battery in which a composite material containing three metal elements in which a part of cobalt of lithium cobaltate is replaced with nickel and manganese is used as a positive electrode. A plurality of ternary battery cells 211 are provided and connected in series.

The voltage sensor 212 is a sensor that measures the voltage of the ternary battery cell 211. The voltage sensor 212 may measure the voltage of each of the ternary battery cells 211 or may measure the voltage of the plurality of ternary battery cells 211. The voltage sensor 212 outputs a signal indicating the measured voltage to the battery-pack ECU 214.

The current sensor 213 is a sensor that measures the current of the ternary battery cell 211. The current sensor 213 measures a current flowing through the plurality of ternary battery cells 211. The current sensor 213 outputs a signal indicating the measured current to the battery-pack ECU 214.

The battery pack ECU 214 generates voltage information and current information of the ternary battery cell 211 based on the received voltage and current, and transmits the generated voltage information and current information to the battery integrated ECU 23. The battery pack ECU 214 drives a relay (not shown) based on the discharge instruction transmitted from the battery integrated ECU 23, and discharges the relay from the ternary battery cell 211.

The battery pack 22 includes a LFP battery cell 221, a voltage sensor 222, a current sensor 223, and a battery pack ECU 224.

LFP battery cell 221 is an iron-phosphate-based lithium-ion battery in which lithium iron phosphate is used as a positive electrode. A plurality of LFP battery cells 221 is provided and connected in series.

The voltage sensor 222 is a sensor that measures the voltage of LFP battery cell 221. The voltage sensor 222 may measure the voltages of the individual LFP battery cells 221 and may measure the voltages of the plurality of LFP battery cells 221. The voltage sensor 222 outputs a signal indicating the measured voltage to the battery pack ECU 224.

The current sensor 223 is a sensor that measures the current of LFP battery cell 221. The current sensor 223 measures a current flowing through the plurality of LFP battery cells 221. The current sensor 223 outputs a signal indicating the measured current to the batter-pack ECU 224.

The battery pack ECU 224 generates voltage information and current information of LFP battery cell 221 based on the received voltage and current, and transmits the generated voltage information and current information to the battery integrated ECU 23. The battery pack ECU 224 drives a relay (not shown) based on the discharge instruction transmitted from the battery integrated ECU 23 and discharges the relay from LFP battery cell 221.

The step-up converter 24 boosts and converts the DC voltage from the battery packs 21 and 22 into an arbitrary DC voltage and outputs the boosted DC voltage to PCS 4. Note that the step-up converter 24 may not be mounted. The battery integrated ECU 23 is a control device that controls charging and discharging of the battery packs 21 and 22. The battery integrated ECU 23 receives the voltage-information and the current-information transmitted from the battery pack ECU 214, 224. The battery integrated ECU 23 estimates the storage condition of the ternary battery cell 211 and LFP battery cell 221 by using the received voltage-information and current-information. The battery integrated ECU 23 transmits the discharging instruction to the battery pack ECU 214, 224.

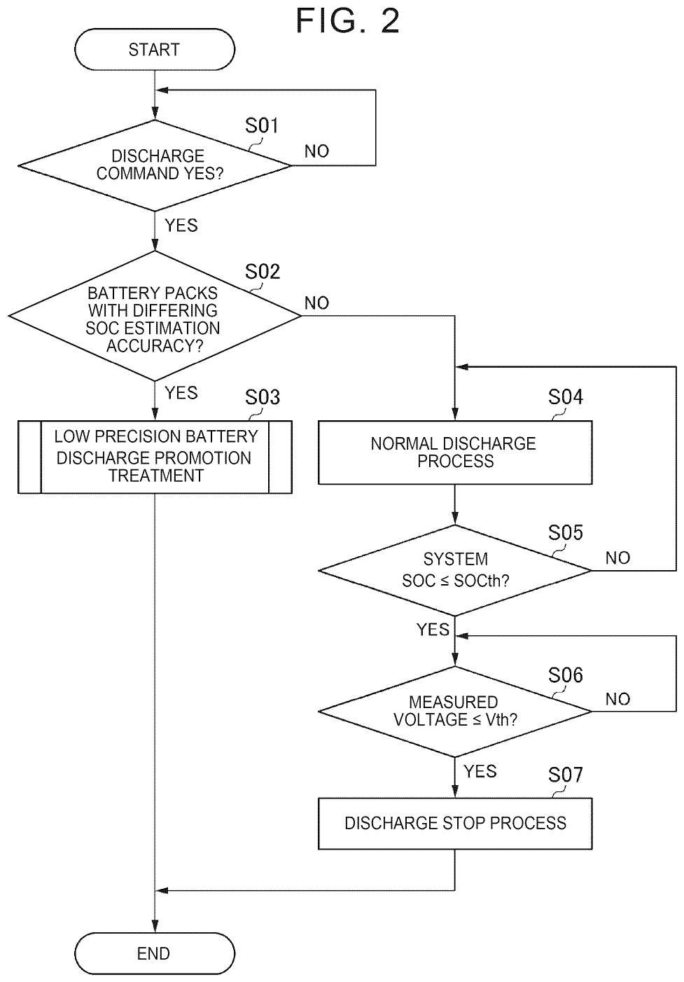

Next, referring to FIG. 2, a process flow of the battery integrated ECU 23 will be described. In S01, the battery integrated ECU 23 determines whether or not there is a discharging command. The discharging command is transmitted from EMS 3. If there is a discharging command (S01: YES), the processing proceeds to S02. If there is no discharging command (S01: NO), the determination of S01 is repeated.

In S02, the battery integrated ECU 23 determines whether or not there is a battery pack that differs in the estimation accuracy of a storage state (hereinafter, also simply referred to as “SOC”) such as a SOC or a remaining capacity. In the present embodiment, as described with reference to FIG. 1, the battery packs 21 and 22 to be controlled by the battery integrated ECU 23 include the ternary battery cells 211 and LFP battery cells 221, respectively, and thus there are battery packs with differing SOC estimation accuracy.

If there are batteries with differing SOC estimation accuracy (S02: YES), processing proceeds to S03. If there are no batteries with differing SOC estimation accuracy (S02: NO), processing proceeds to S04. S07 from S04 is a process that is not a process that includes a battery pack with differing SOC estimation accuracy as described with reference to FIG. 1. Before describing S03, the process of S07 from S04 will be described.

In S04, the battery integrated ECU 23 performs a normal discharge process in accordance with the discharge command. The normal discharging process is, for example, a process of uniformly discharging all the battery packs when SOC of all the battery packs is within a certain range.

In a S05 following S04, the battery integrated ECU 23 determines whether SOC is less than or equal to the threshold SOCth. SOC is SOC of the entire power storage device, and can be obtained, for example, as the mean of SOC of all the battery packs included in the power storage device. The threshold SOCth is a threshold value set as requiring voltage monitoring when a system SOC falls below the threshold value.

If SOC≤SOCth (S05: YES), processing proceeds to S06. If it is not a system SOC≤SOCth (S05: NO), processing proceeds to S04.

In S06, the battery integrated ECU 23 determines whether the measured voltage V is less than or equal to the threshold voltage Vth. The measured voltage is a value obtained by measuring the voltage of each cell or the voltage of the battery pack. If the measured voltage V≤the threshold voltage Vth (S06: YES), the processing proceeds to S07. If the measured voltage V≤the threshold voltage Vth (S06: NO), S06 process is repeated. In S07, the battery integrated ECU 23 executes the discharging-stopping process and ends the process.

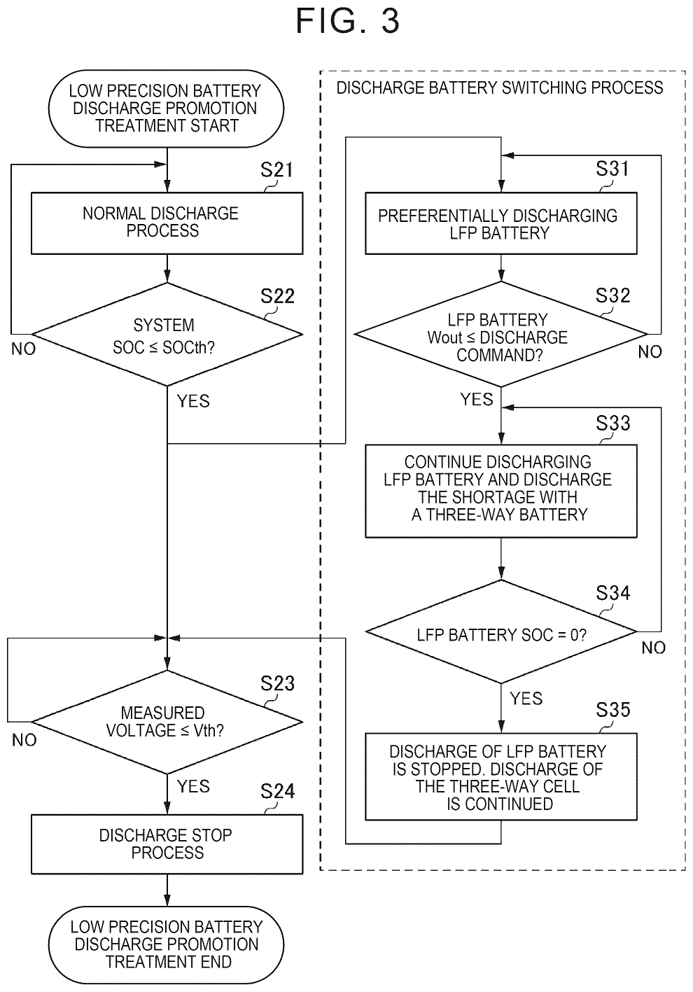

In S03 where S02 is determined to be a process in which the estimation accuracy of SOC differs, the battery integrated ECU 23 executes the discharge-promoting process of the low-precision battery. The discharge promotion process of the low-precision battery will be described with reference to FIG. 3.

In S21 of FIG. 3, the battery integrated ECU 23 performs a normal discharge process in accordance with the discharge command. The normal discharging process is, for example, a process of uniformly discharging all the battery packs when SOC of all the battery packs is within a certain range.

In a S22 following S21, the battery integrated ECU 23 determines whether SOC is less than or equal to the threshold SOCth. SOC is SOC of the entire power storage device, and can be obtained, for example, as the mean of SOC of all the battery packs included in the power storage device. The threshold SOCth is a threshold value set as requiring voltage monitoring when a system SOC falls below the threshold value.

If SOC≤SOCth (S22: YES), processing proceeds to S23, S31. If it is not a system SOC≤SOCth (S22: NO), processing proceeds to S21.

In S23, the battery integrated ECU 23 determines whether the measured voltage V is less than or equal to the threshold voltage Vth. The measured voltage is a value obtained by measuring the voltage of each cell or the voltage of the battery pack. If the measured voltage V≤the threshold voltage Vth (S23: YES), the processing proceeds to S24. If the measured voltage V≤the threshold voltage Vth (S23: NO), S23 process is repeated. In S24, the battery integrated ECU 23 executes the discharging-stopping process and ends the process.

Next, the discharging-battery switching process including the process of S31, S32, S33, S34, S35 will be described. The voltage checking described in the above S23,24 is executed in parallel during the discharge battery switching process, and the discharge stopping process is executed when the measured voltage V becomes equal to or lower than the threshold voltage Vth even during the discharge battery switching process.

In S31, the battery integrated ECU 23 executes a preferential discharging process of LFP battery cell 221. The battery integrated ECU 23 transmits a discharge command to the battery pack ECU 224, and transmits a discharge stopping process to the battery pack ECU 214.

In S32 following S31, the battery integrated ECU 23 determines whether or not the dischargeable value Wout of LFP battery cell 221 is equal to or less than the discharging command value. The dischargeable-value Wout of LFP battery cell 221 is transmitted from the battery pack ECU 224 to the battery integrated ECU 23 at any time.

If the dischargeable value Wout≤discharge command value or less (S32: YES), the processing proceeds to S33. If the dischargeable value Wout≤discharge command value or less (S32: NO), the processing proceeds to S31.

In S33, the battery integrated ECU 23 executes the preferential discharge process of LFP battery cell 221, and executes the process of compensating the shortage of the discharge command by the discharge of the ternary battery cell 211. The battery integrated ECU 23 transmits a discharge command to the battery pack ECU 224 so as to continue discharging corresponding to the dischargeable-value Wout of LFP battery cell 221. The battery integrated ECU 23 transmits a discharge command to the battery pack ECU 214 so as to perform discharge corresponding to a difference between the discharge command value and the dischargeable value Wout.

In S34 following S33, the battery integrated ECU 23 determines whether or not SOC of LFP battery cell 221 becomes 0. When SOC of LFP battery cell 221 reaches 0 (S34: YES), processing proceeds to S35. If SOC of LFP battery cell 221 is not zero (S34: NO), processing proceeds to S33.

In S35, the battery integrated ECU 23 stops the discharge process of LFP battery cell 221, and executes the process of performing the discharge corresponding to the discharge command in the ternary battery cell 211. The battery integrated ECU 23 transmits a discharge-stop command for LFP battery cell 221 to the battery pack ECU 224. The battery integrated ECU 23 transmits a discharge command to the battery pack ECU 214 so as to perform discharge corresponding to the discharge command. When S35 process is finished, the process proceeds to S23.

The present embodiment has been described above with reference to specific examples. However, the present disclosure is not limited to these specific examples.

Those skilled in the art with appropriate design modifications to these specific examples are also included in the scope of the present disclosure as long as they include the features of the present disclosure. Each element included in each of the above-described specific examples and the arrangement, condition, shape, and the like thereof are not limited to those illustrated, and can be appropriately changed. Each element included in each of the above-described specific examples can be appropriately combined and changed as long as there is no technical inconsistency.

### Additional Remarks

The following Appendices 1 to 4 can be arbitrarily combined as long as they are not technically inconsistent.

### Appendix 1

A plurality of kinds of secondary batteries,

A control device for determining a discharge order of a plurality of kinds of secondary batteries,

In the power storage device, when a value indicating a storage state of the entire plurality of kinds of secondary batteries becomes equal to or smaller than a threshold value, the control device preferentially discharges a low-precision battery included in the plurality of kinds of secondary batteries and having a relatively low estimation accuracy of the storage state, rather than a high-precision battery included in the plurality of kinds of secondary batteries and having a relatively high estimation accuracy of the storage state.

In the power storage device 2 of the present embodiment, the low-precision battery exemplifies LFP battery cell 221, the high-precision battery exemplifies the ternary battery cell 211, and the control device exemplifies the battery integrated ECU 23. The low-accuracy battery is not limited to LFP battery cell, as long as the estimation accuracy of the power storage condition is relatively low. The high-precision battery is not limited to a three-way battery as long as the estimation accuracy of the storage state is relatively high.

According to Appendix 1, since the low-precision battery is preferentially discharged when the value indicating the storage state of the entire secondary battery becomes equal to or less than the threshold value, the low-precision battery with low estimation accuracy of the storage state is discharged first, and when the storage state of the entire secondary battery is lowered, the high-precision battery is mainly discharged, so that the estimation accuracy of the storage state of the entire secondary battery can be improved.

### Appendix 2

The power storage device according to Appendix 1, wherein the control device discharges the low-precision battery and suppresses discharge of the high-precision battery when a value indicating a storage state of the entire plurality of kinds of secondary batteries becomes equal to or less than a threshold value.

According to Appendix 2, when the value indicating the storage state of the entire secondary battery becomes equal to or less than the threshold value, the low-precision battery is discharged, and the discharge of the high-precision battery is suppressed, so that the low-precision battery can be discharged first without lowering the storage state of the high-precision battery.

In the above-described embodiment, the discharge of the high-precision battery is stopped, but the discharge of the high-precision battery is not necessarily stopped, and it is possible to suppress the discharge of the high-precision battery to such an extent that the discharge of the low-precision battery is prioritized.

### Appendix 3

The power storage device according to Appendix 2, wherein, as a result of preferentially discharging the low-precision battery, the control device suppresses discharging of the low-precision battery and discharges the high-precision battery when a value indicating a storage state of the low-precision battery becomes equal to or less than a threshold value.

According to Appendix 3, as a result of the preferential discharge of the low-precision battery, the discharge of the low-precision battery is suppressed when the storage amount of the low-precision battery decreases, and the high-precision battery is discharged, so that the high-precision battery is mainly discharged when the storage state of the entire secondary battery decreases, and the estimation accuracy of the storage amount of the entire secondary battery can be improved.

### Additional Remark 4

The power storage device according to any one of Appendices 1 to 3, wherein the high-precision battery is a ternary lithium ion battery, and the low-precision battery is an iron phosphate lithium ion battery.

What is claimed is:

1. A power storage device comprising:
a plurality of kinds of secondary batteries; and
a control device configured to determine discharge order of the plurality of kinds of secondary batteries, wherein the control device is configured to, when a value indicating an overall power storage state of the plurality of kinds of secondary batteries is equal to or less than a threshold value, discharge a low-accuracy battery included in the plurality of kinds of secondary batteries and having a relatively low accuracy of estimation of a power storage state with priority over a high-accuracy battery included in the plurality of kinds of secondary batteries and having a relatively high accuracy of estimation of a power storage state.

2. The power storage device according to claim 1, wherein the control device is configured to discharge the low-accuracy battery and suppress discharging of the high-accuracy battery when the value indicating the overall power storage state of the plurality of kinds of secondary batteries is equal to or less than the threshold value.

3. The power storage device according to claim 2, wherein the control device is configured to suppress discharging of the low-accuracy battery and discharge the high-accuracy battery when a value indicating the power storage state of the low-accuracy battery is equal to or less than a threshold value as a result of discharging the low-accuracy battery with priority.

4. The power storage device according to claim 1, wherein the high-accuracy battery is a ternary lithium ion battery, and the low-accuracy battery is an iron phosphate lithium ion battery.
